(19) United States
(12) Patent Application Publication
(10) Pub. No.: US 2005/0229932 A1
(43) Pub. Date: Oct. 20, 2005

(54) Passenger oxygen mask

(76) Inventors: Wolfgang Rittner, Siblin (DE); Rudiger Meckes, Berkenthin (DE)

Correspondence Address: MCGLEW & TUTTLE, PC, P.O. BOX 9227, SCARBOROUGH STATION, SCARBOROUGH, NY, 10510-9227, US

(21) Appl. No.: 11/099,109

(22) Filed: Apr. 5, 2005

(30) Foreign Application Priority Data
Apr. 20, 2004 (DE) 10 2004 019 685.0

(51) Int. Cl. A62B 18/02

(52) U.S. Cl. 128/205.25

(57) ABSTRACT

A passenger oxygen mask with a flexible mask body with at least one section of the mask body which is designed plastically deformable or is provided for accommodating a plastically deformable support element.

### CROSS REFERENCE TO RELATED APPLICATIONS

This application claims the benefit of priority under 35 U.S.C. § 119 of DE 10 2004 019 685.0 filed Apr. 20, 2004, the entire contents of which are incorporated herein by reference.

### FIELD OF THE INVENTION

The invention relates to a passenger oxygen mask with a flexible mask body.

### BACKGROUND OF THE INVENTION

Passenger oxygen masks are provided on board of an aircraft in order in an emergency situation and in the phase of a post decompression altitude drop of the aircraft, to supply the passengers with oxygen, as well as to provide therapeutic oxygen for passengers who require oxygen during normal flight operation.

Known passenger oxygen masks usually have a rotationally symmetrical mask body whose circular breathing opening in the case of application is applied to the passenger on the facial region around the nose and mouth. Due to the circular cross section of the mask body, the passenger oxygen mask does not always bear completely on the face of the user so that an intermediate space between the face and the mask body remains open and thus remains permeable to air. These intermediate spaces result to a greater or lesser extent depending on the facial physiognomy. A not insignificant large quantity of oxygen is lost through this gap with oxygen masks which provide a constant flow of oxygen. Oxygen masks with which the oxygen supply is only effected when a valve arranged in the mask boy is opened due to a breathing impulse are very difficult or may not even be activated by the user, since the vacuum in the mask body required for opening the valve may not be built up due to the intermediate spaces between the mask body and the face. With passengers this may lead to hypoxia.

### SUMMARY OF THE INVENTION

Against this background, it is the object of the present invention to provide a passenger oxygen mask which provides the user with a sufficient quantity of oxygen is a secure manner, and at the same time may be manufactured in a simple and inexpensive manner.

The passenger oxygen mask according to the invention comprises a flexible, preferably rotationally symmetrical mask body. At least one section of the mask body is designed such that it may be plastically deformed or is envisaged for receiving a plastically deformable support element.

The soft-elastic mask body is preferably rotationally symmetrical and is formed with a circular breathing opening. This is particularly required for the operational safety of the passenger oxygen mask since the oxygen masks may thus, for example in panic situations, be placed on and applied in all positions with regard to the axis. After the passenger has calmed down, the oxygen mask may be positioned correctly as the case may be. Subsequently it is possible to deform the plastic section of the mask body and thus to adapt the opening region of the mask body to the contour of the face, by which means the open intermediate space between the mask body and the face is minimized or closed.

The mask body in the region of the contact surface to the nose of the user is preferably designed in a plastically deformable manner, since the mask body in this region is particularly distanced from the remaining surface of the face due to the topography of the face.

It may also be advantageous to design the mask body in a completely flexible manner and to place a support element on the mask body in the region of the nose which is so deformable that it forces the breathing opening of the mask body onto the surface of the face with as little gaps as possible.

Advantageously on the mask body, a region which is annular in the peripheral direction is designed plastically deformable. This plastically deformable region is preferably arranged near to the breathing opening of the mask body. In this manner, the whole contour of the breathing opening may be adapted to the contact region with the face.

If the mask body is deformed by way of the accommodation of a support element, this support element is preferably formed of a metallic material. The support element is preferably of a thin, easily bendable sheet metal or is formed of a wire structure, wherein the dimensions of the sheet metal or the wire structure are adapted to the size of the mask section to be deformed, and permit a simple deformation of the support element. A wire structure for example permits a particularly weight-saving embodiment of the support element, by which means the wearing comfort of the oxygen mask may be improved. All metals which ensure that the support element may be plastically deformed without any particularly large force effort may be used as a material for the support element.

In a further advantageous embodiment of the invention, the support element is formed of a plastic. This plastic is plastically deformable and may accommodate the restoring forces which originate from the deformed mask body.

Apart from a design of the support element consisting completely of plastic or metal there also exists the possibility of manufacturing the support element of a combination of these materials, wherein this combination must also fulfill the above mentioned demands with regard to the plastic deformability and the shape consistency. For example, a design of the support element with which a metallic wire structure is cast in a base body of the support element which consists of plastic is conceivable. Due to the wire structure, the used plastic in this case may also be designed in an elastically deformable manner.

Usefully, a pocket for receiving the support element is arranged on the outer peripheral surface of the mask body. The pocket is preferably positioned on the section of the mask body, which on use of the passenger oxygen mask is located above the nose of the user. The pocket is preferably designed as an insert compartment into which the support element may at least partly be introduced. Alternatively tabs which fix the support element at least at its distanced ends on the mask body may form the pocket. The support element, after provisionally placing on the oxygen mask, may at a later phase be inserted into the pocket by the passenger or the flight crew, and subsequently, located in the pocket, be deformed according to the facial contour.

A further preferred embodiment envisages the support element and/or the mask body comprising bonding surfaces. With the help of this bonding surface, the support element, after it has been positioned on the mask body and has been deformed according to the facial contour, may be fixed on the mask body. It is particularly advantageous if the bonding surface on the mask side is designed in the form of a peripheral ring since then the support element may be attached in every position of the mask on suitable position, specifically above the nose of the user without the mask previously having to be rotated in a certain position. This may also be achieved for the previously described embodiments if for example the plastically deformable metal structure incorporated in the mask body is peripheral or the pocket for incorporating the support element is formed by a peripheral, lip-like pocket.

In a further advantageous embodiment of the passenger oxygen mask, the clamping element and the mask body comprise adhesive surfaces which together form a type of Velcro closure (hook and loop fastener). At the same time one adhesive surface is formed as a fluffy fleece surface and the other corresponding adhesive surface as a surface with small hooks, so that on attaching the support element on the mask body, many small hooks of the adhesive surface of the support element form a hook-loop connection with the adhesive surface of the mask body, and the support element rigidly adheres to the mask body, but where appropriate, may be easily detached by the user of the oxygen mask. Here too, the adhesive surface on the mask side is usefully formed in a peripheral manner.

The support element and the mask body preferably comprise adhesive surfaces in the form of nano adhesive surfaces. These adhesive surfaces in the nano region have surface structures which on joining together mesh with one another such that the support element rigidly adheres to the mask body. With this embodiment variant too it is useful to design the bonding surface on the mask body side as a peripheral ring.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

The invention is hereinafter explained by way of embodiment examples shown in the drawings. There are shown in:

FIG. 1 a perspective representation of a passenger oxygen mask with a plastically deformable section integrated into the mask body;

FIG. 2 a perspective representation of a passenger oxygen mask with a support element arranged on the mask body; and

FIG. 3 a perspective representation of a passenger oxygen mask with a pocket for receiving the support element, said pocket being arranged on the mask body.

### DETAILED DESCRIPTION OF THE INVENTION

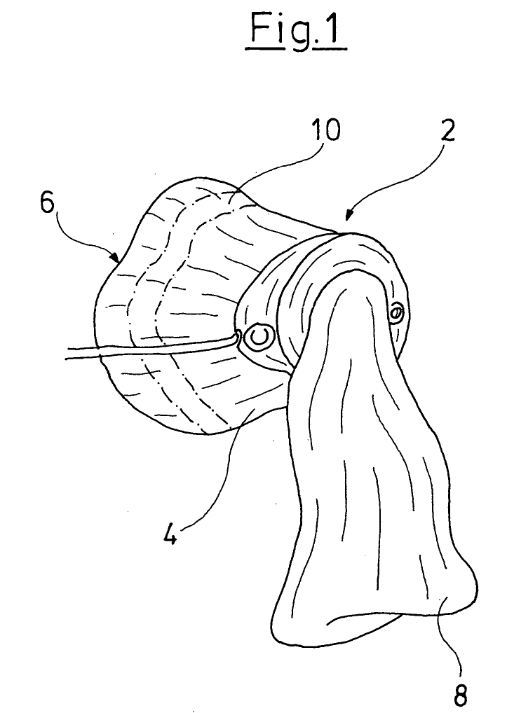

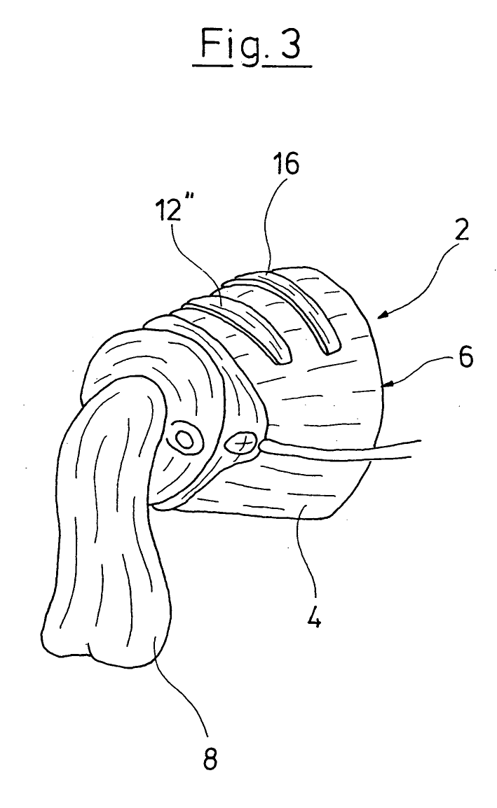

Referring to the drawings in particular, FIGS. 1 to 3 in each case show a passenger oxygen mask 2 with a mask body 4 consisting of a soft-elastic plastic, which at a first end comprises a breathing opening 6. From FIG. 3 it is evident that the mask body 4 in its undeformed condition is designed in a rotationally symmetrical manner in the shape of a truncated cone. Accordingly the breathing opening 6 in the undeformed condition has a circular cross sectional area. In the known manner, the supply of oxygen, a storage bag 8 as well as an auxiliary air valve are arranged at the other end of the mask body 4 which is distanced from the breathing opening 6.

The mask body 4 represented in FIG. 1 has a plastically deformable section 10 in the vicinity of the breathing opening 6. This section 10 extends in a strip-like manner over the whole periphery of the mask body 4. In FIG. 1 the plastically deformable section 10 is arranged by way of a sheet metal strip embedded in the inside of the mask body 4. The sheet metal strip may just as easily be arranged on the inside on the mask body 4 or on the outer wall of the mask body 4.

The plastically deformable section 10 may alternatively consist of a plastically deformable plastic which is cast or bonded on the inner or outer peripheral surface of the mask body 4, or is cast into the mask body 4. Furthermore the section 10 may also be formed of one or more wires or of a wire weaving. These wires or the wire weaving are then fixed on the inner or outer peripheral surface of the mask body 4 or are integrated into the mask body 4.

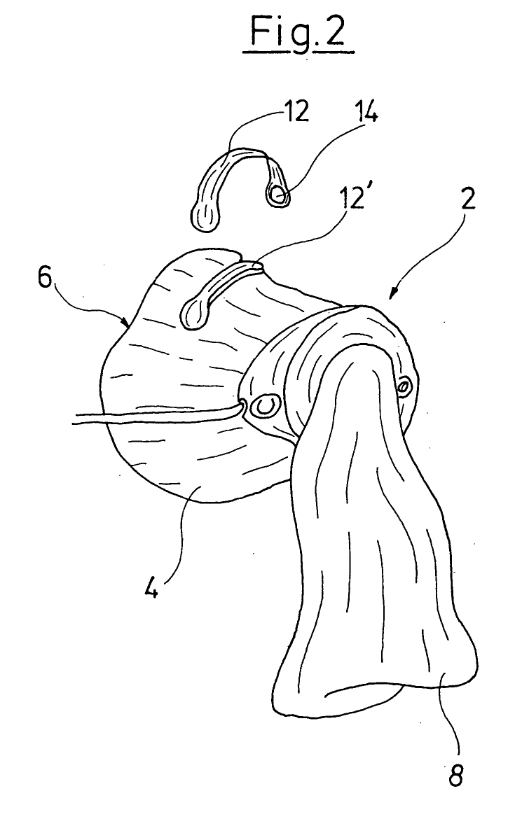

FIG. 2 shows a passenger oxygen mask 2 which is adapted to the facial contour by way of a support element 12. In the figure, the support element 12 is represented individually and before the attachment on the mask body 4 as well as a support element 12′ arranged on the mask body 4. The support element 12′ is arranged in the region of the mask body 4 which in the case of the application of the passenger oxygen mask 2 covers the nose of the user. In order to be able to fasten the support element 12 on the outer wall of the mask body 4, the support element 12 on its side which faces the mask body 4 comprises a bonding surface 14. The bonding surface 14 may, as shown, only cover part regions of the side of the support element 12 which faces the mask body 4 or however be arranged on the whole surface of that side of the support element 12 which faces the mask body 4. Instead of the bonding surface 14, the support element 12 at the same location may alternatively comprise an adhesive surface. In this case the mask body 4 also on its outer peripheral surface comprises an adhesive coating which corresponds with the adhesive surface of the support element 12, and permits a fixation of the support element 12 on the mask body 4.

With the passenger oxygen mask 2 represented in FIG. 3, a pocket 16 is arranged on the outer wall of the mask body 4. This pocket 16 serves for receiving a support element 12″ which after correctly placing on the passenger oxygen mask 2 is inserted into the pocket 16. In the figure, the support element 12″ is represented before the insertion into the pocket 16. The support element 12″ consists of a plastically deformable material such as e.g. a plastically deformable plastic, of a metal or of a pairing of these materials. If the support element 12″ is located in the pocket 16 it is deformed such that the mask body 4 is adapted to the facial contour.

While specific embodiments of the invention have been shown and described in detail to illustrate the application of the principles of the invention, it will be understood that the invention may be embodied otherwise without departing from such principles.

1. A passenger oxygen mask, comprising:
a flexible mask body, wherein at least one section of the mask body is designed in a plastically deformable manner or is provided for receiving a plastically deformable support element.

2. A passenger oxygen mask according to claim 1, wherein said mask body includes a user face contact portion designed in a rotationally symmetrical manner.

3. A passenger oxygen mask according to claim 1, wherein said mask body includes an annular region designed in a plastically deformable manner.

4. A passenger oxygen mask according to claim 1, wherein said support element is formed of a metallic material.

5. A passenger oxygen mask according to claim 1, wherein said support element is formed of a plastic material.

6. A passenger oxygen mask according to claim 1, wherein said mask body has an outer peripheral surface with a pocket for receiving said support element.

7. A passenger oxygen mask according to claim 1, wherein said support element includes a bonding surface and said mask body includes a bonding surface.

8. A passenger oxygen mask according to claim 1, wherein said support element and said mask body comprise adhesive surfaces which together form a Velcro-type closure.

9. A passenger oxygen mask according to claim 1, wherein said support element and said mask body comprise adhesive surfaces in the form of nano adhesive surfaces.

10. A passenger oxygen mask according to claim 1, wherein the fastening means on the mask body side are designed peripherally around the mask body.

11. A passenger oxygen mask, comprising:
a flexible mask body; and
plastically deformable means associated with said body for providing a plastically deformable region of said mask body whereby at least a portion of the flexible mask body may be deformed to a shape with the shape substantially maintained by the plastically deformable means.

12. A passenger oxygen mask according to claim 11, wherein said plastically deformable means comprises a plastically deformable support element connected to said flexible mask body.

13. A passenger oxygen mask according to claim 12, wherein said mask body includes a user face contact portion that is rotationally symmetrical in a non deformed state.

14. A passenger oxygen mask according to claim 11, wherein said mask body includes an annular region with said plastically deformable means for plastic deformation of said annular region.

15. A passenger oxygen mask according to claim 12, wherein said support element is formed of one or more of a metallic material and a plastic material.

16. A passenger oxygen mask according to claim 12, wherein said mask body has an outer peripheral surface with a pocket for receiving said support element.

17. A passenger oxygen mask according to claim 12, wherein said support element includes a bonding surface and said mask body includes a bonding surface.

18. A passenger oxygen mask according to claim 12, wherein said support element and said mask body comprise adhesive surfaces which together form a hook and lop fastener for fastening said support element to said mask body.

19. A passenger oxygen mask according to claim 12, wherein said support element and said mask body comprise adhesive surfaces in the form of nano adhesive surfaces.

20. An airplane passenger oxygen mask, comprising:
a flexible mask body with a user face contact portion that is substantially rotationally symmetrical; and
a plastically deformable portion disposed in or along said body whereby at least a portion of the flexible mask body may be deformed to a shape with the shape substantially maintained at said face contact portion.
